(19) United States
(12) Patent Application Publication
(10) Pub. No.: US 2024/0337337 A1
(43) Pub. Date: Oct. 10, 2024

(54) IMPROVEMENTS TO A JOINT BETWEEN OIL AND GAS PIPE SECTIONS

(71) Applicant: High Sealed and Coupled 'HSC' FZCO, Dubai (AE)

(72) Inventor: Matthew HIGNETT, Great Yarmouth (GB)

(21) Appl. No.: 18/293,737

(22) PCT Filed: Aug. 16, 2022
(86) PCT No.: PCT/IB2022/057658

§ 371 Date: Jan. 30, 2024

(30) Foreign Application Priority Data
Aug. 16, 2021 (GB) 2111728.8

(51) Int. Cl. F16L 15/06; E21B 17/042; F16L 15/00

(52) U.S. Cl. CPC F16L 15/06; F16L 15/001; E21B 17/042

(57) ABSTRACT

A screw-threaded joint for pipes is disclosed comprising a first pipe length having a pin screw threaded portion at one end and a second pipe length having a box portion at one end, the ends each having a screw thread complementary to that on the other pipe length, the threads being adapted to inter-engage along the greater part of the axial length thereof, the threads being inclined in the same direction and at an acute angle to the central longitudinal axis of the joint, the pin thread extending at least to a stop shoulder having a head portion having a substantially conical cross-section which is positioned adjacent a complementary stop shoulder on the box portion.

### FIELD OF THE INVENTION

The present invention relates to a joint between pipe sections, which pipe sections are for use in the oil and gas sector for downhole drilling and extraction. The invention is also concerned with the provision of an improved thread and stop shoulder region on a pin and box section to provide improved sealing and resistance to galling, erosion and corrosion. In a further aspect of the invention there is provided an improved method of constructing a fluid-tight seal between a pin section and a box section.

### BACKGROUND TO THE INVENTION

Within the oil and gas extraction industry a variety of different pipe sections is utilised to transport fluid between locations. The pipe sections are assembled together into a continuous pipeline, often referred to as a string. It is important therefore that the joint between adjacent pipe sections be fluid tight: not just on initial make up, but also over a prolonged time to minimise downtime of the string. The strings themselves need to be able to withstand the particular conditions to which they are subjected and the volumes they are required to transport. For example, the conditions of operation for a pipe string incorporated in the extraction process from a reserve below ground or sea level are far different from those where the string is transporting overland: perhaps to a refinery or as part of the gas distribution network between regions of a country or countries.

The particular usage of the pipe strings discussed herein is for extraction of the raw gas or oil product from a well to transport to the surface. As such, the conditions experienced by the pipe sections and in particular the joints therebetween are relatively harsh. The joints need to be able to withstand axial compression and tensive forces, large pressure differentials across their width as well as corrosive components of the fluid being transported. Additionally, subterranean pipe strings are often highly deviated to enable the string to extend along a horizontal reserve. The deviation causes differential strains across individual joints: acting to compress one side and to stretch the other side. A joint must therefore be able to withstand, simultaneously, compressive and tensive forces. In addition to the above, once a pipe string has carried out a task, the string is preferably removed, and the individual pipe sections can be separated for reuse: often when a pipe string has been in operation for a period of several years. A pipe section need therefore to be able to be made up and broken a number of times with other pipe sections without losing performance.

It is an object of the present invention to provide an improved pipe joint which is able to withstand the conditions of use and reuse. It is a further object of the invention to provide a pipe section and a box section having a thread and joint region which provides an improved joint and which enables a joint to be made up and broken repeatedly.

### SUMMARY OF THE INVENTION

According to a first aspect of the invention, there is provided a screw-threaded joint for pipes comprising a first pipe length having a pin screw threaded portion at one end and a second pipe length having a box portion at one end, the ends each having a screw thread complementary to that on the other pipe length, the threads being adapted to interengage along the greater part of the axial length thereof, the threads being inclined in the same direction and at an acute angle to the central longitudinal axis of the joint, the pin thread extending at least to a stop shoulder having a head portion having a conical cross-section which is positioned adjacent a complementary stop shoulder on the box portion, the complementary stop shoulder comprising a cone receiver having a conical cross-section, the cone receiver adapted to sealingly receive the head portion, a substantially planar surface on the head portion of the pin section sealingly engaging a corresponding substantially planar surface on the cone receiver of the box section, wherein the angle subtended by each of the substantially planar surfaces to the joint axis is from 29.5°-30.5°.

The co-planarity of the sealing surfaces reduces galling on make-up of the joint.

Preferably, the final pin thread is cropped by removal of the foremost surface of the final crest to reduce the risk of galling on make up.

Preferably, the lengths of the sealing surface and link surface on the pin section are different from the lengths on the corresponding sealing and link surfaces of the box section.

Preferably, the combined axial lengths of the sealing surface and the link surface of the pin section are greater than the combined axial lengths of the corresponding sealing surface and link surfaces on the box section to ensure the torque shoulders on the pin and box sections respectively contact each other before the crest on the pin engages the crest of the thread on the box.

Preferably, the angle subtended by the torque shoulders with respect to the perpendicular to the pin and box sections' axes is 20°+/−0.5°.

Preferably, the angle subtended by each of the substantially planar link surfaces to the joint axis is 30.0°.

Preferably, the radial sealing surfaces on the pin and box sections are substantially planar.

Preferably, there is clearance between sealing surfaces of the pin and box sections on make-up of the joint to prevent hydraulicing.

According to a second aspect of the invention, there is provided pipe section having at an end a pin screw threaded portion, the thread being adapted to interengage along the greater part of the axial length thereof with a complementary thread on a pipe section having a box screw-threaded portion, the pin thread extending at least to a stop shoulder having a head portion comprising a conical cross-section having a substantially planar surface, wherein the angle subtended by the substantially planar surface to the pipe section axis is from 29.5°-30.5°.

According to a third aspect of the invention, there is provided pipe section having at an end a box screw threaded portion, the thread being adapted to interengage along the greater part of the axial length thereof with a complementary thread on a pipe section having a pin screw-threaded portion, the box thread extending at least to a stop shoulder having a head portion comprising a complementary stop shoulder on the box portion, the complementary stop shoulder comprising a cone receiver having a conical cross-section, the cone receiver adapted to sealingly receive a head portion of a pin section, the cone receiver of the box section having a substantially planar surface, wherein the angle subtended by the substantially planar surface to the pipe section axis is from 29.5°-30.5°.

### BRIEF DESCRIPTION OF THE DRAWINGS

The invention is now described with reference to the accompanying drawings which show by way of example only, two embodiments of a joint, and one embodiment of the shoulders of a pipe section and box section. In the drawings:

FIG. 1 illustrates a pin shoulder;

FIGS. 2a, 2b illustrate a pin and a box shoulder respectively;

FIG. 3 illustrates engagement of the pin and box shoulders of FIG. 2;

FIG. 4 illustrates engagement of the pin and box shoulders of FIG. 2;

FIG. 5 illustrates a coupling for two pin shoulders;

FIG. 6 illustrates shows a typical torque curve on make-up of the joint of FIG. 5; and

FIG. 7 illustrates the stress forces in made-up a joint.

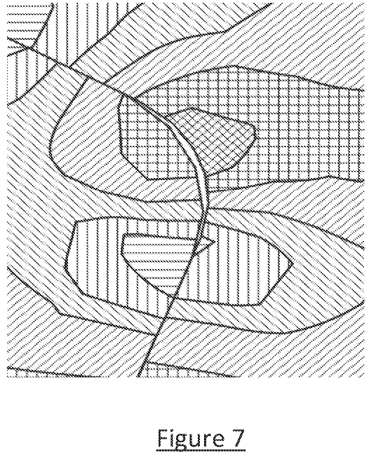

### DETAILED DESCRIPTION OF THE INVENTION

As discussed above, it is important when designing pipe sections for downhole use in the oil and gas industry, that the connections with adjacent pipe sections in the overall pipe string be fluid tight. The most common means of achieving this is to provide the end of each section with a threaded portion to enable the two sections to be secured. At each end of a pipe is a sealing section which is specifically profiled, usually by machine-cutting into the pipe section during manufacture, to engage with a corresponding sealing section on the neighbouring pipe section to form the seal. To this end in the prior art there are myriad different forms for the sealing section. Moreover, many joints are disclosed having additional seal elements secured to, or set into recesses of, the sealing section to provide sealing in addition to any metal-metal seal in the joint.

The current invention provides a sealing section which, by virtue of its particular profile, seals to the adjacent section by means of a metal-metal seal between sealing shoulders of adjacent pipe sections. The seal formed is resistant to the forces and conditions described above. Moreover, the lack of additional seal elements, has advantages in that, such seal elements, often formed of a synthetic polymeric material, can degrade which weakens their functioning and can also lead to particles breaking off and passing into the fluid being conveyed.

With regard to the current invention, each pipe section can be formed at each end into what is referred to herein as a box shoulder or a pin shoulder. Alternatively, one end of the pipe section can be formed as a box shoulder and the other a pin shoulder. Generally, a box section is formed having a thicker wall and a larger outside diameter (OD) than a pin section. In use, pipe sections are secured together by mating the pin end of one section with the box end of the other section. In an alternative embodiment of the invention, a coupling joint is used, the coupling joint having two threaded portions and sealing shoulders to sealingly join two pipe sections together.

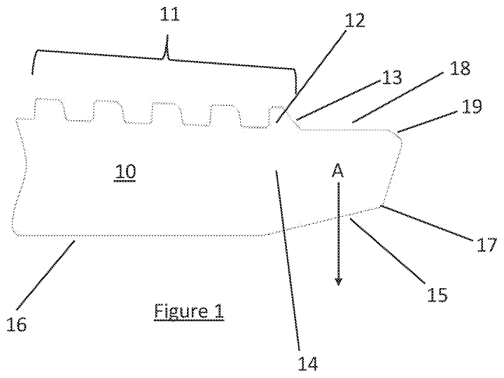

Referring now to FIG. 1, this illustrates a pin section, generally referenced 10. The wall thickness of the pipe from which the pin section 10 is formed and from which the pin shoulder is machined is such that its thickness is in conformity with API 5CT specification. So, the wall thickness of the pipe from which the pin connection is machined is-12.5% of the pipe's nominal wall thickness, by the pipe's linear mass tolerance of −3.5% to +6.5% of the nominal linear mass. To clarify, in use each pipe is produced and ordered by OD and wall thickness. For example, given 4½″ (OD)×0.271″ (wall thickness). The wall thickness would need therefore to be a minimum of −12.5% of the 0.271″ nominal wall thickness. There is no maximum tolerance. Also, the linear mass would also need to be −3.5% to +6.5% of the theoretical linear mass of a piece of the above 4½″×0.271″ pipe. This thickness allows for the fact that a pipe section from which a shoulder is formed rarely has a perfectly circular cross-section, but there is always an eccentricity in the shape and thickness of the pipe wall. The eccentricity and variations allowed in the raw manufactured pipe wall are such however, that use of the above formula in determining wall thickness allows that the inner diameter (ID) of the pin is still sufficient. Moreover, the shoulder of the pin is still sufficiently thick to provide the necessary strength within the eventually formed connection.

The OD of the pin section is made to within the tolerances set out in the Standard API 5CT and should be within +1% or −0.5% of the required OD. So, for example, where an outside diameter is set to be 4.5″, the acceptable outside diameter is from 4.4775″-4.545″.

During the manufacturing process, the machining of the threads simply runs out until there is no metal left to machine. A certain “minimum perfect thread length” is required so it can be guaranteed there is enough strength in the threaded area to hold the connection together once made up with the coupling (box thread). If the criteria for the OD from API 5CT is not met and the OD is too small, then there is not enough metal to machine the threaded section to meet the minimum perfect thread length. What is left is “black crested threads”, which is simply the black surface of the pipe body. Herein, a perfect thread is one in which the thread profiles have been machined such that they conform to the profile required. It is acknowledged in the industry that every connection will have a portion of imperfect thread because they are produced on the ¾ taper per foot, meaning the thread will always simply runout and leave behind a certain amount of imperfect thread. What the above criterion ensures is that sufficient perfect threads can be produced before the natural runout begins leaving the imperfect threads.

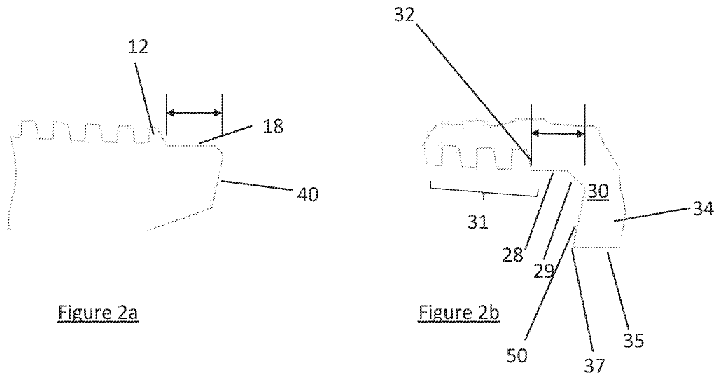

The pin section 10 has a threaded portion 11, the end of which is visible in FIG. 1. The threaded portion 11 allows the pin section 10 to be threadably connected to a box section 30 (see FIG. 2b) which has a complementary threaded section 31. The crests of the threaded portion 11 are of uniform cross-section along the majority of the length of the threaded portion 11. However, the final crest 12 is cropped by cutting the forwardmost surface 13 of the crest 12. This reduces the risk of galling occurring through engagement of surface 13 of the crest 12 with the crest wall of the threaded section 31. The galling leads to a weakening of the seal produced between the pin and box sections 10, 30 and can lead to the escape of fluid from the pipe string.

In order to further ensure that the thread crest 12 does not come into galling contact with the final crest 32 of the thread 31 of the box section 30, the regions of the radial sealing surface 18 and link surface 19 on the pin shoulder 14, which surfaces 18, 19 on make-up of the joint engage the corresponding radial surfaces 28 and link surface 29 on the box shoulder 34 are of different lengths to these corresponding surfaces. The combined axial lengths of the surfaces 18, 19 is greater than the combined axial length of the surfaces 28, 29. This ensures that the torque surfaces 40, 50 on the pin and box shoulders respectively contact each other before the crest 12 on the pin engages the crest 32 of the thread 31 on the box. In the embodiment shown, the angle subtended by the torque shoulders with respect to the perpendicular to the pin and box sections' axes is 20°+/−0.5°.

Following make-up of the joint, the pin shoulder 14 is caused to bend in the general direction A towards the pin axis. This results in the end surface 15 of the inner surface 16 being brought into line with the inner surface 16, and also aligns both the inner surfaces 15, 16 with the inner surface 35 of the box section 30. There is thereby produced a continuous surface without any step changes of the inner bore diameter of the pipe string. This reduces turbulence in the flow of the fluid within the pipe and also minimises erosion and corrosion which occurs most readily at locations of high curvature. In other embodiments, the bending of the pin shoulder 14 is not so great but is nevertheless of sufficient magnitude to bring the apex 17 adjacent the corresponding apex 37 on the box shoulder 34.

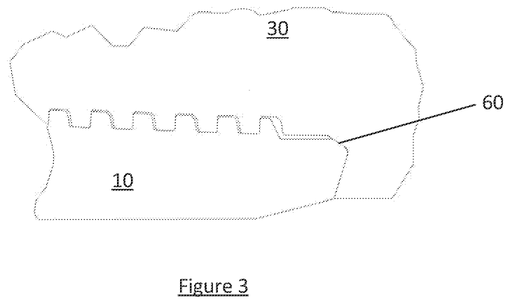

Referring now to FIG. 3, this shows a joint following make-up. In FIG. 3 it can be seen that the threads of the pin section 10, and the box section 30 are engaged. The seal 60 is created between the two surfaces 19 and 29 on the pin and box sections respectively. These surfaces, generally, are annular and straight in cross-section (referred to herein as planar) and subtend an angle of around 30° with the axis of the pin or box sections 10, 30. The angle subtended by the surfaces 19, 29 is selected to be from 29.5° to 30.5° to the axis. The two surfaces 19, 29 are preferably parallel to each other. In making up the seal, torque is applied until the two torque surfaces 40, 50 engage. Torque then continues to be applied, which forces the energy thus imparted to be stored within the pin and box shoulders 14, 34, and in particular energising the seal 60. The energising of this seal enables the seal 60 to withstand the internal and external pressures to which the pipe string is subjected in use. The seal can at the same time resist both tensive and compressive forces: including where these are applied to regions of the same joint. Tests up to those required to ISO13679 for Premium Connections have been successful.

Within the defined values for which the joint is designated, the material from which the pin and the box sections 10, 30 are formed is not subjected to forces sufficient to cause plastic flow. Were such flow to occur then the material would be weakened and its properties then risk being insufficient to cope under use conditions. Otherwise however, the material retains its desired elastic properties and the sections can be reused.

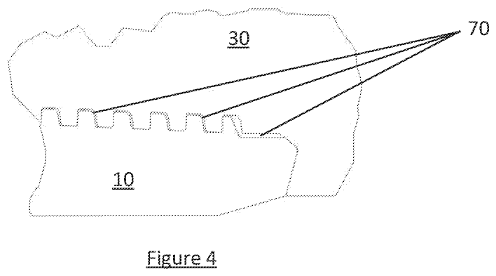

In FIG. 4, it can be seen that there is clearance (shown by arrows 70) between the pin section 10 and the box section 30. The clearance prevents a phenomenon referred to in the art as ‘hydraulicing’ in which grease, applied, before make-up, to the pin and the box sections, to aid make-up and reduce the risk of galling, remains trapped therebetween. As the torque is applied, pressure on the grease builds up. In the absence of the clearance, the grease has nowhere to go to release the pressure. Eventually the pressure becomes such that the grease forces its way out leading to what appears as uneven bursts of torque. The clearance 70 therefore enables the grease to be evenly distributed between the pin and box sections.

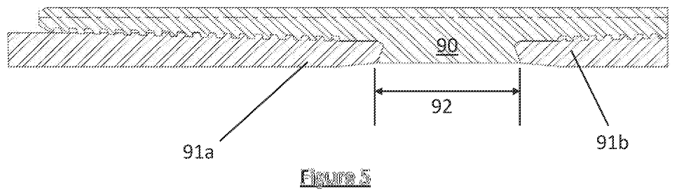

FIG. 5 illustrates a second embodiment of joint in accordance with the invention. In this a pipe section coupling 90 functions, in effect as two box sections within the scope of the invention. The coupling 90 acts to couple 2 pin sections 91a, 91b together. The coupling 90 has two threaded portions and profiles each corresponding to that of the box section 30 described above. The threaded portions and profiles are separated by a J-section 92. Although such couplings 90 are known in the art, the coupling 90 differs from those in the art in that the width of the J-section 92 is greater than in similar couplings. This acts to reduce hoop stress generated when, following coupling of one pin section 91a, the second pin section 91b is coupled to the pin section 91a/coupling 90 assembly. The hoop stresses arise when the stress imparted from one pin section coupling extends to the stress imparted by coupling of the other pin section. The interaction of these stresses is unpredictable in effect and can lead to failure of either or both joints.

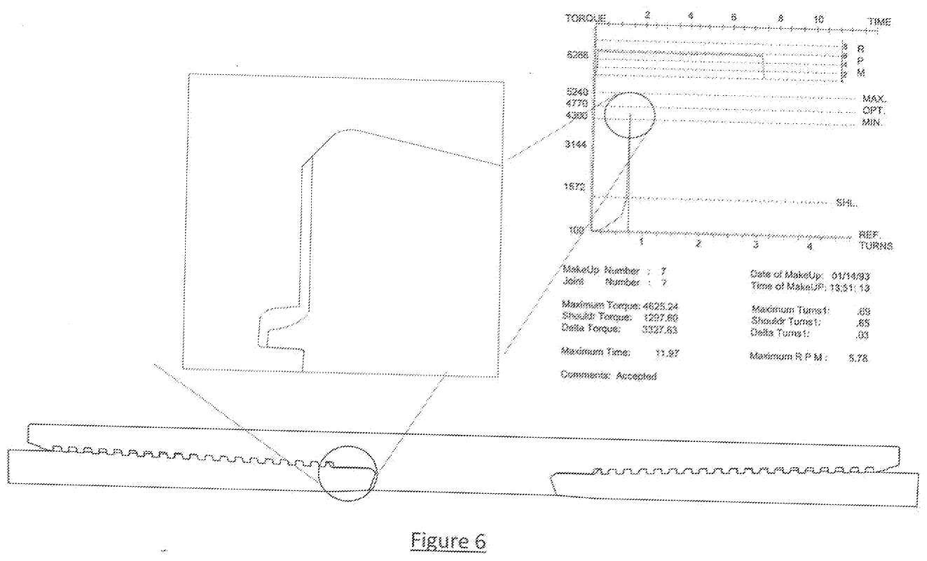

FIG. 6 illustrates the torque applied during make-up of a joint in accordance with the current invention. Moving from left to right in the direction of number of turns applied, the y-axis shows the torque applied. As the coupling 90 and the pin section 91a are coupled together, the torque applied rises fairly smoothly until the point of engagement between the torque surfaces engage. At this point the torque applied rises sharply. This point indicates also that the sealing surfaces 19, 29 are sealingly engaged. An operator is therefore provided with a clear means of knowing when the seal has been formed, minimising the risk of under- or over-tightening.

1. A screw-threaded joint for pipes comprising a first pipe length having a pin screw threaded portion at one end and a second pipe length having a box portion at one end, the ends each having a screw thread complementary to that on the other pipe length, the threads being adapted to inter-engage along the greater part of the axial length thereof, the threads being inclined in the same direction and at an acute angle to the central longitudinal axis of the joint, the pin thread extending at least to a stop shoulder having a head portion having a substantially conical cross-section which is positioned adjacent a complementary stop shoulder on the box portion, the head portion comprising a sealing surface, a torque surface and a link surface linking the sealing surface to the torque surface, the complementary stop shoulder comprising a cone receiver having a substantially conical cross-section, the cone receiver adapted to sealingly receive the head portion and comprising a sealing surface, a torque surface and a link surface linking the sealing surface to the torque surface, a link surface on the pin section having a planar cross-section to sealingly engage a corresponding substantially planar link surface on the cone receiver of the box section, wherein the angle subtended by each of the substantially planar link surfaces to the joint axis is from 29.5°-30.5°.

2. The screw-threaded joint according to claim 1, wherein the final pin thread is cropped by removal of the foremost surface of the final crest.

3. The screw-threaded joint according to claim 1, wherein the lengths of the sealing surface and link surface on the pin section are different from the lengths on the corresponding sealing and link surfaces of the box section.

4. The screw-threaded joint according to claim 3, wherein the combined axial lengths of the sealing surface and the link surface of the pin section are greater than the combined axial lengths of the corresponding sealing surface and link surfaces on the box section.

5. The screw-threaded joint according to claim 1, wherein the angle subtended by the torque shoulders with respect to the perpendicular to the pin and box sections' axes is 20°+/−0.5°.

6. The screw-threaded joint according to claim 1, wherein the angle subtended by each of the substantially planar link surfaces to the joint axis is 30.0°.

7. The screw-threaded joint according to claim 1, wherein the sealing surfaces on the pin and box sections are substantially planar.

8. The screw-threaded joint according to claim 1, wherein there is clearance between sealing surfaces of the pin and box sections on make-up of the joint.

9. A pipe section having at an end a pin screw threaded portion, the thread being adapted to interengage along the greater part of the axial length thereof with a complementary thread on a pipe section having a box screw-threaded portion, the pin thread extending at least to a stop shoulder having a head portion comprising a substantially conical cross-section having a substantially planar surface, wherein the angle subtended by the substantially planar surface to the pipe section axis is from 29.5°-30.5°.

10. A pipe section having at an end a box screw threaded portion, the thread being adapted to interengage along the greater part of the axial length thereof with a complementary thread on a pipe section having a pin screw-threaded portion, the box thread extending at least to a stop shoulder having a head portion comprising a complementary stop shoulder on the box portion, the complementary stop shoulder comprising a cone receiver having a substantially conical cross-section, the cone receiver adapted to sealingly receive a head portion of a pin section, the cone receiver of the box section having a substantially planar surface, wherein the angle subtended by the substantially planar surface to the pipe section axis is from 29.5°-30.5°.
